(19) United States
(12) Patent Application Publication
(10) Pub. No.: US 2008/0124553 A1
(43) Pub. Date: May 29, 2008

(54) Heat dispersing enclosure

(76) Inventors: Terrance Davidson Hurt, Bakersfield, CA (US); Matthew P. Chamberlain, Humble, TX (US)

Correspondence Address: Terrance Davidson Hurt, 18133 Buckboard Avenue, Bakersfield, CA, 93314, US

(21) Appl. No.: 11/986,231

(22) Filed: Nov. 19, 2007

Related U.S. Application Data
(60) Provisional application No. 60/860,106, filed on Nov. 20, 2006.

(51) Int. Cl. B32B 9/00

(52) U.S. Cl. 428/411.1

(57) ABSTRACT

The Heat Dispersing Enclosure is an apparatus specifically developed to portion and diffuse the exhaust generated by a 30 watt thermoelectric generator. In accordance with its design and intended application, the apparatus achieves touchable surface temperatures on all exposed surface areas of the Heat Dispersing Enclosure.

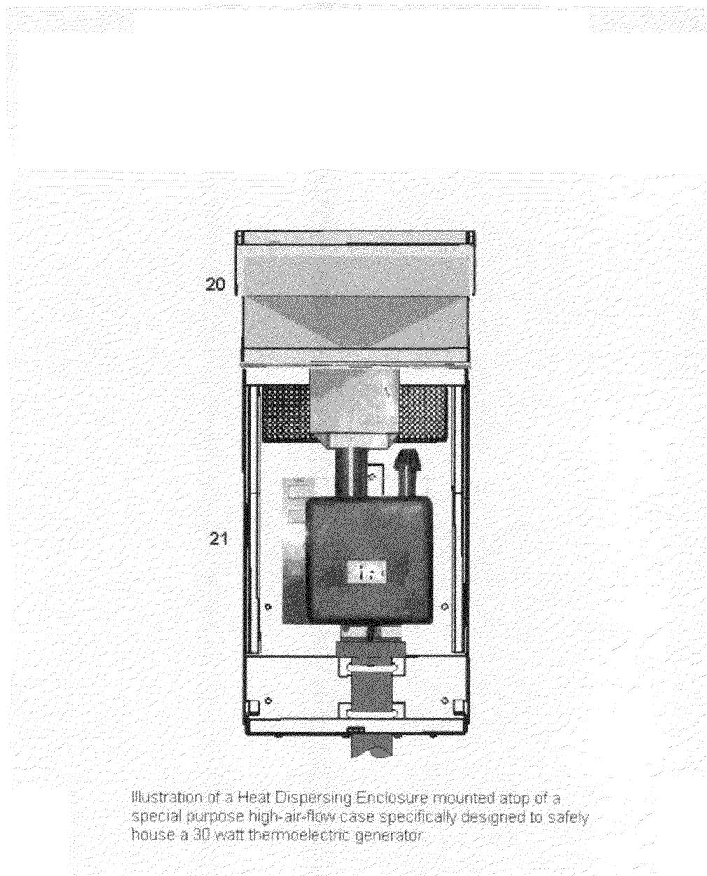

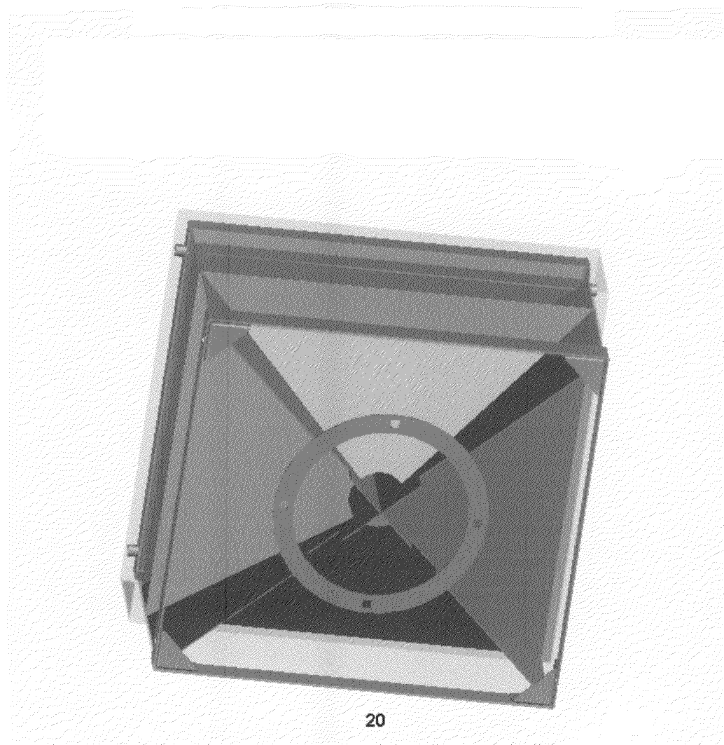

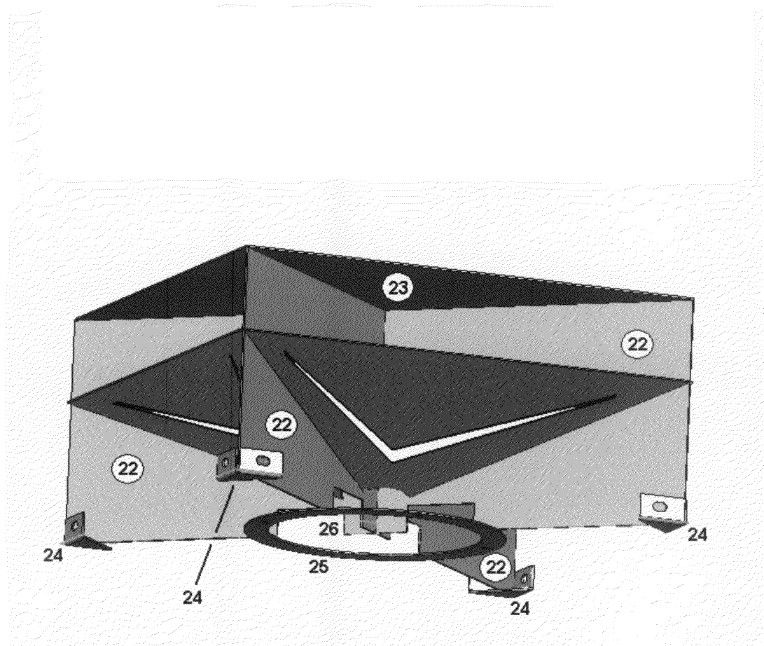

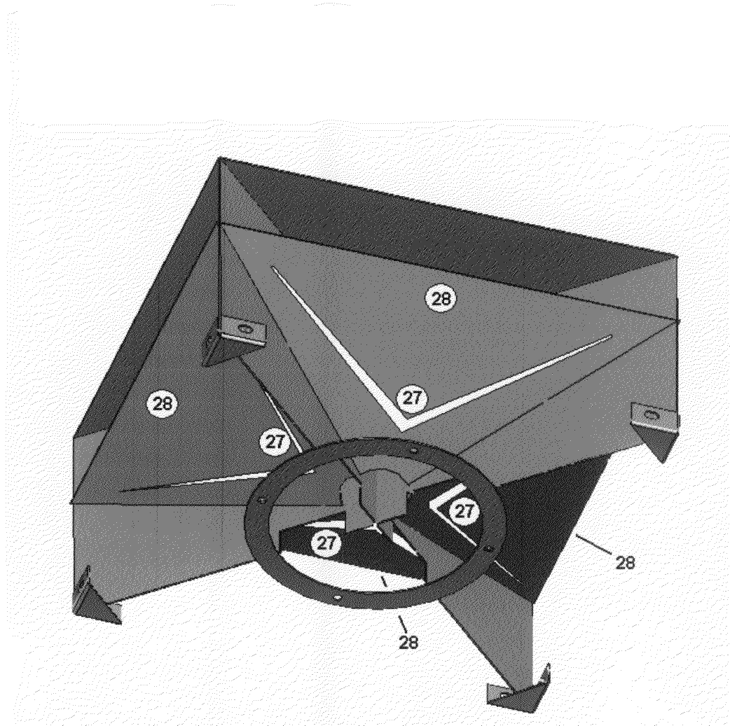

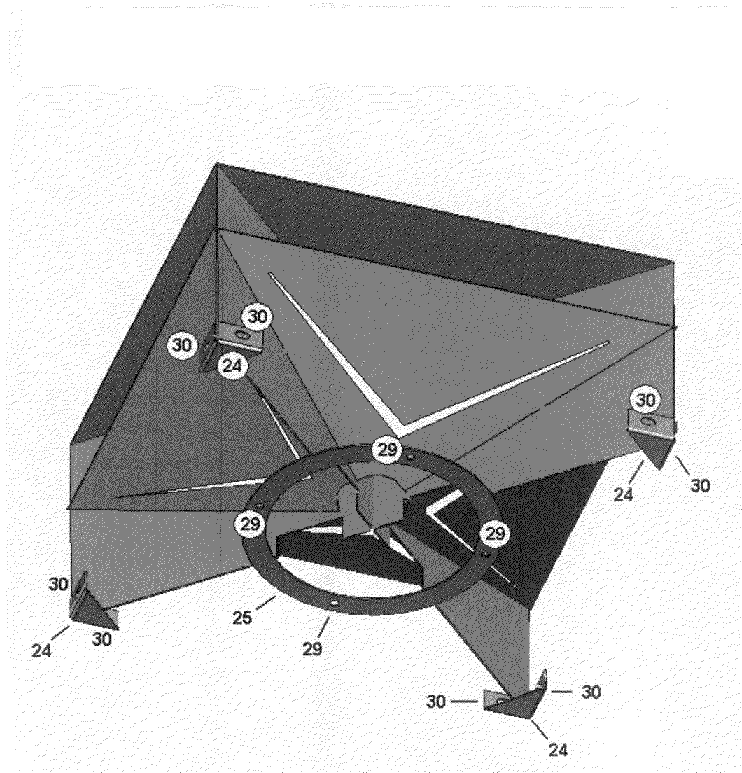

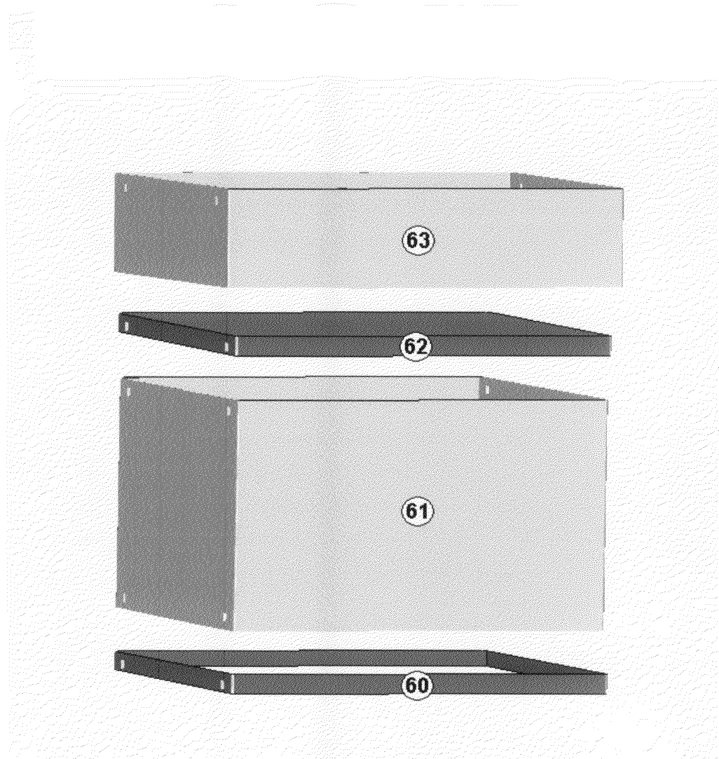

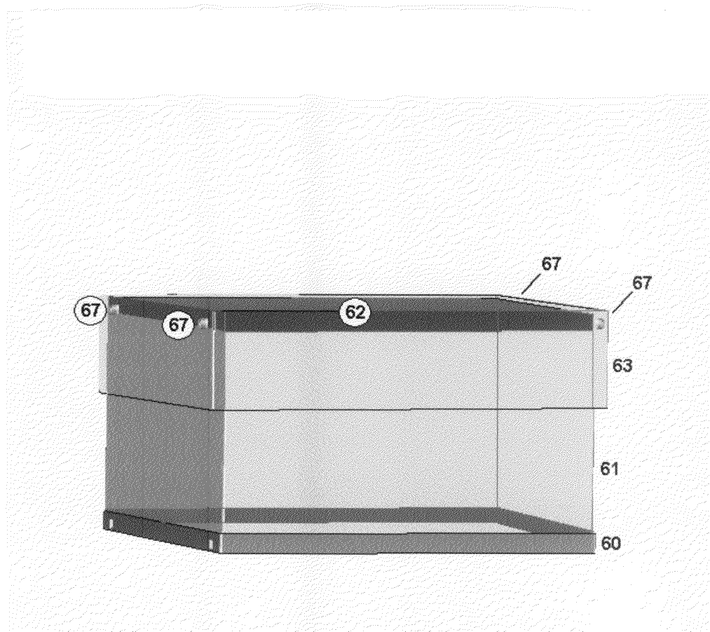

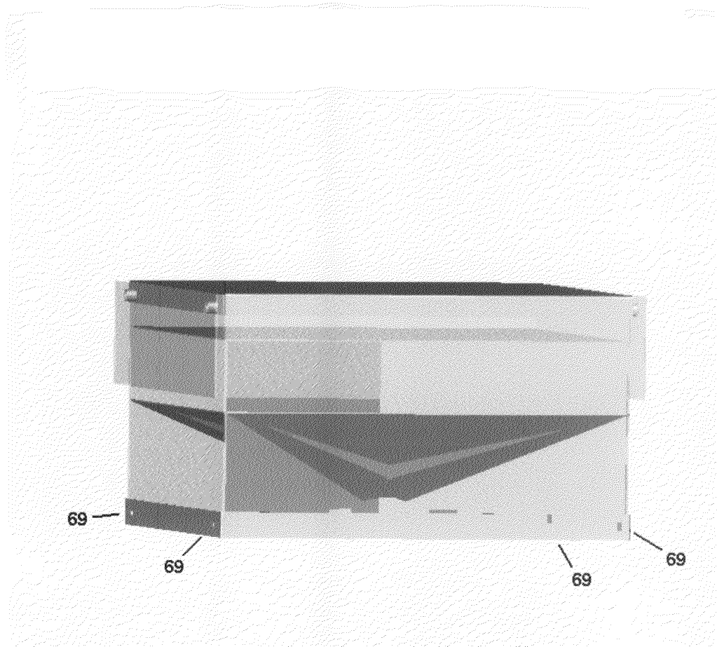

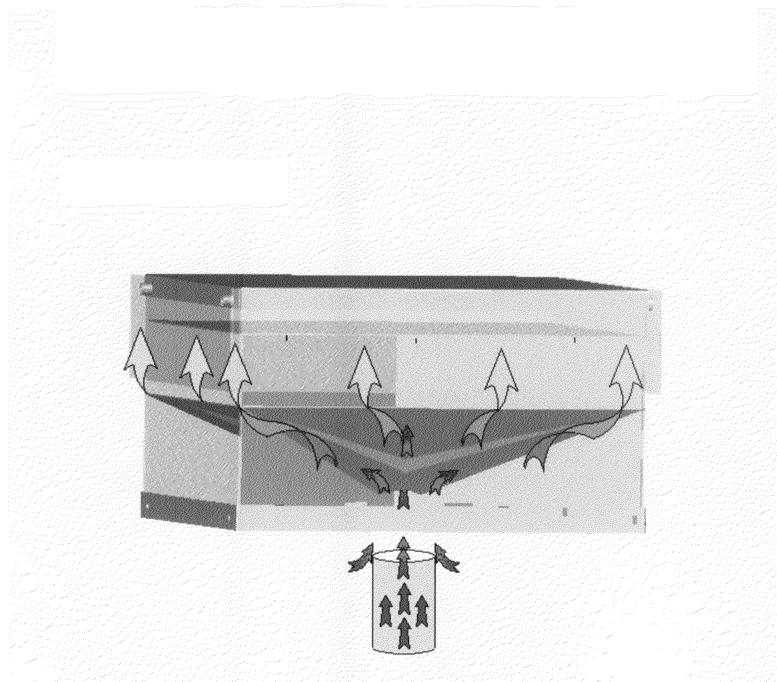

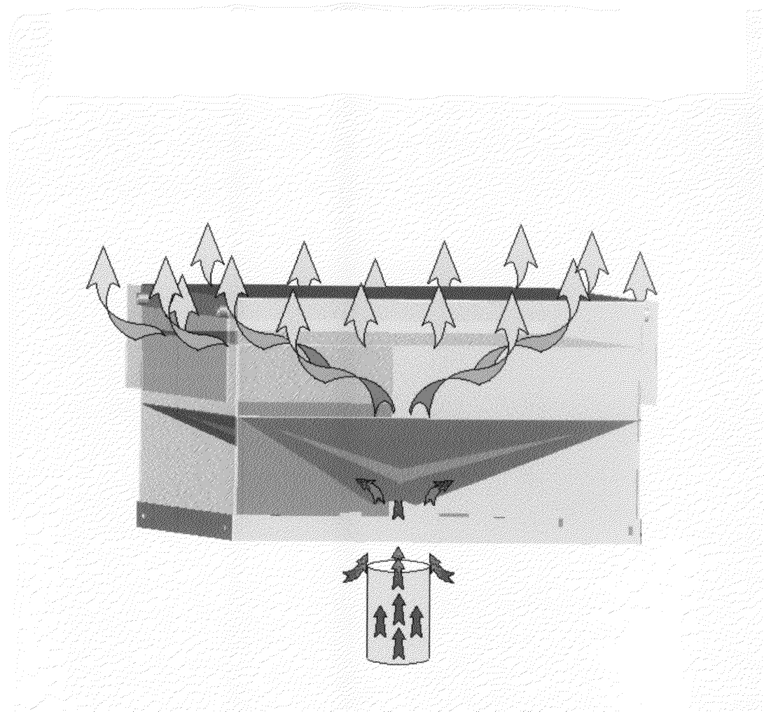

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO LISTING, AT TABLE, OR A COMPUTER PROGRAM LISTING COMPACT DISC APPENDIX

Not Applicable

### BACKGROUND OF INVENTION

Many industries (such as oil and gas, public utilities, municipalities and others) make extensive use of buried and or immersed metallic structures to transport and store product. It is well known that such metallic structures will corrode and deteriorate over time. It is therefore extremely important that measures be taken to protect against such corrosion and deterioration. One such measure is to coat the buried or immersed metallic structures to prevent it from contacting a conductive environment (electrolyte). However, coatings alone have proven ineffective as a principle means of protecting against corrosion and deterioration principally due to incomplete seals and degradation of the coating over a period of time.

A more reliable means of preventing metallic corrosion is through the application of cathodic protection. This practice recognizes that corrosion comes about as a result of low-level electrical reactions taking place between metallic elements of different voltage potential when exposed to, or immersed in, a conductive electrolyte. In such environments, metal of a more negative voltage potential will emit low levels of electrical current which, by way of the electrochemical process, results in metal loss, otherwise stated as corrosion. The application of cathodic protection utilizes this same principle by introducing a sacrificial metal into the electrical circuit. In order to be affective, the sacrificial metal must have a more negative potential than the most negative element of the metal to which cathodic protection is being applied. Moreover, It has been observed that if the most negative voltage potential of the metallic structure to which cathodic protection is being applied can be increased (made more negative) by a value of 0.1 volt or more, this same naturally occurring corrosion process of the metallic structure surface may be avoided. This can be accomplished by various methods, one of which involves introducing certain other metals (such as magnesium, referred to as a “sacrificial anode”) into the electrical circuit of the desired metallic structure. This particular method, commonly referred to as galvanic corrosion control, involves attaching a wire between a sacrificial anode and the metallic structure. The natural conductivity of the electrolyte then causes the corrosion process to occur on the sacrificial anode's surface, instead of on the metallic structure's surface.

Of the methods used to apply cathodic protection, the galvanic corrosion control method is limited by way of the natural driving voltage potential of the sacrificial anode. In the case of magnesium (the most commonly used sacrificial anode), the maximum driving voltage may be no greater than −1.70 volt. While this driving voltage is sufficient to protect well coated buried or immersed metallic structure in conductive electrolyte, it has proven ineffective in the case of poorly coated metallic structure in a similar environment. To address this issue, operators make use of a different method of applying cathodic protection that involves the use of impressed current.

Impressed current corrosion control designs use an external apparatus to impress, or drive, DC electricity off of a sacrificial anode. The advantage to these systems is that they can be controlled by the operator to achieve driving voltages well above those associated with the sacrificial metals used in the galvanic corrosion control method. The most common method of applying cathodic protection by impressed current involves converting AC electricity into DC electricity by way of a process commonly known as rectification. This process uses an appliance called a rectifier to convert (or rectify) AC electricity into DC electricity by channeling the AC electricity through a series of electrical components known as diodes. The diode components are unique in their design in that they only allow electrical current to flow in one direction. When assembled into a unidirectional configuration (commonly referred to as a bridge), DC electricity is produced from the utility supplied AC power grid. For the most part, this method of applying impressed current cathodic protection depends upon having access to the utility supplied electric power grid. As such, when access to the electric power grid is not feasible, operators must seek-out other means of applying impressed.

Yet another method of applying impressed current is the use of batteries in conjunction with solar array panels. These systems are limited with respect to their ability to effectively sustain impressed current in areas where climatic conditions limit exposure to direct sunlight. Additionally, these systems have a limited corrosion control application based upon the battery element's inability to reliably and continuously meet the cathodic protection current demands of poorly coated metallic structure.

Of the remaining available methods of applying impressed current corrosion control to poorly coated metallic structure buried or immersed in a conductive electrolyte, thermoelectric generation seems to be the most viable. This method produces DC electricity by way of the thermoelectric process. More particularly described, the thermoelectric process generates DC electricity by creating a temperature differential across a reactive element commonly referred to as a thermocouple. To optimize the thermoelectric process, thermoelectric generators use an assembly of thermocouples called a thermopile. To achieve the required temperature differential, thermoelectric generators normally burn either propane or natural gas to create a high temperature zone on one end of the thermopile, while exposing the other end of the thermopile to ambient temperature by way of a heat dispersing material, typically aluminum. These devices have proven an effective and reliable means of generating impressed DC current as they contain no moving parts and use a reliable fuel source. As such, they are commonly viewed as a viable remote power option in those situations where access to the electric power grid is not practical. However, the expense of a high power thermoelectric device, along with the associated fuel expense, limits their application to critical installations.

The low powered thermoelectric device differs from the high powered version in that it is affordable in terms of both initial expense and operating costs. Moreover, the compact low power 30 watt thermoelectric device is uniquely suited to meet the ever increasing corrosion control current demands of our aging natural gas pipeline infrastructure. Specifically, those natural gas pipeline operators that apply cathodic protection to poorly coated metallic structure by way of the sacrificial anode process transport the very fuel needed to generate low powered impressed current. This is significant in that one low power 30 watt thermoelectric generator has the ability to accomplish what might otherwise require as many as ten sacrificial anode installations. However, concerns for persons coming in contact with the thermoelectric generators hot exhaust require that certain measures be taken to protect public health and safety. Most common among these measures is to install a barrier such as a chain link fence. The intent is to prevent accidental exposure that might result in a heat related injury. Such measures severely limit the natural gas industry's ability to make meaningfully use of these low powered thermoelectric devices, chiefly because of the area requirements associated with a fenced impressed current corrosion control installation. It is therefore desirable to provide methods and apparatus capable of sufficiently reducing the low powered 30 watt thermoelectric generator's exhaust temperature so that concern for persons coming in direct contact with the device's hot exhaust is no longer a health and safety issue.

### BRIEF SUMMARY OF THE INVENTION

The present invention provides heat dispersing apparatus and related methods utilizing a heat dispersing enclosure designed specifically for a low powered 30 watt thermoelectric generator. The is significant in that operators applying cathodic protection to poorly coated buried or submerged metallic structures in conductive electrolyte without the ability to access to the electric power grid now have a viable option for applying low powered impressed current by way of thermoelectric generation. Absent this option, operators must continue with the existing practice of installing sacrificial magnesium anodes at an ever increasing rate.

### BRIEF DESCRIPTION OF THE SEVERAL VIEWS OF THE DRAWING

1/10 Front Facing View mounted atop of a cased 30 watt thermoelectric generator
2/10 Up View
3/10 Internal Side View
4/10 Internal Up View
5/10 Internal Up View
6/10 Exploded View of External Housing
7/10 Assembled View of External Housing
8/10 Transparent View of Assembled Enclosure
9/10 Primary Heat Dispersion Illustration
10/10 Secondary Heat Dispersion Illustration

### DETAILED DESCRIPTION OF THE INVENTION

In the preferred embodiment of the invention, the Heat Dispersing Enclosure 20 is installed atop of a well ventilated case 21 specifically designed to safely house a 30 watt thermoelectric generator. It should be noted that superior air flow characteristics are critical to all such case designs as thermoelectric generators are, by their very nature, dependant upon air flow to achieve rated power.

At the center base of the Heat Dispersing Enclosure, Four identical Thirteen and One Half Inch Long by Nine and One Half Inch High vertically aligned plates 22 consisting of Fourteen Gauge ¼″ perforated stainless steel converge and are welded together. Each plate 22 has a Three Inch Long by One and One Quarter Inch High notch 26 removed from the bottom length that begins outward at a positioned located One and One Quarter Inch from the center of the Apparatus. The leading edge of each notch serves as a ‘slip type’ mounting mechanism for Five Inch ducted tube. The purpose of this design is to facilitate coupling the Heat Dispersing Enclosure to a variety of ducting systems, all designed to evacuate the thermoelectric generators hot exhaust from the case.

A concentric ring made of Fourteen Gauge stainless steel plate 25 measuring One Inch in Width and Eleven Inches in diameter is attached to the vertical assembly of perforated plates 22 by weld method. The concentric ring 25 contains Four square holes 29 equally spaced and concentrically aligned; each sized to accept a 7/16″ stainless steel carriage bolt. The holes 29 are provided to adapt the Heat Dispersing Enclosure 20 to a variety of case designs.

At the outermost corners of each vertically installed perforated plate 22 are fabricated Fourteen Gauge stainless steel corner brackets 24 that contain Two square holes each 30; each sized to accept a 7/16 stainless steel carriage bolt. These corner brackets are used to bolt the internal element of the Heat Dispersing Enclosure to the exterior enclosure base 60.

Resting atop of the vertical assembly of perforated plates 22 is a Nineteen and One Half Inch square 14 Gauge stainless steel plate 23 that serves as an internal ceiling, or barrier. The purpose of the barrier is to prevent hot-spots from forming on the top of the apparatus 20. The barrier accomplishes this by maintaining a Two and One Half Inch air gap between the barrier 23 and the top most surface of the apparatus 20. The barrier 23 is joined to the vertical assembly of plates 22 by weld method.

The vertical assembly of plates 22 are joined by weld method to Four identical Fourteen Gauge stainless steel plates 28 that function as an inverted hopper. Measuring Nineteen Inches at the greatest running length, each plate is fitted in identical fashion, giving way to a Five Inch rise from the center most point of the apparatus to the outer most point of the apparatus where each terminates Two Inches beneath the internal barrier 23. At the center most point of convergence, each hopper plate 28 has a portion of material removed in the fashion of a concentric arch equal to ¼ of a Three Inch diameter hole. By design, this feature of the apparatus allows a fifth potion of the thermoelectric generator's exhaust to bypass the four hopper plate assemblies 28 thereby furthering the heat dissipation process.

To maximize the distribution of the thermoelectric generators hot exhaust over the hopper plates 28, as it rises from the center most point of the apparatus, flow deflectors 27 made of Fourteen Gauge stainless steel are positioned as illustrated in Drawing 4/10. Each deflector, identical in both size and shape, gives way uniformly from a height of One Inch at the center most point, to a height of ¼″ at the distant most point. Oriented, then welded to the hopper plates 28, the center of each deflector 27 lies Five Inches distant the center most point of the apparatus 20, and terminate at a location Two Inch distant the most proximate vertical plate 22, and Four Inch distant the outer most point of the apparatus 20.

The above described assembly makes possible touchable surface temperatures along all surface areas of the exterior Heat Dispersing Enclosure, more particularly described as an apparatus comprised of four sub-assemblies including the base 60; the primary perforated structure 61; the lid 62; and the secondary perforated structure 63. The base 60 is made from Fourteen Gauge stainless steel and attaches to the primary perforated structure 61 by weld method. The primary perforated structure 61 is made from Fourteen gauge 3/16″ perforated stainless steel and is attached to the lid 62 by weld method. The lid 62 is made from Fourteen gauge stainless steel and attaches to the secondary perforated structure 63 by way of Four 7/16″ by One Inch carriage bolts inserted through Four (⅝″ OD by ⅛″ wall) stainless steel spacers ½″ in length 67. Upon finished assembly, the exterior assembly slides over the interior assembly and fastens together by way of Four 7/16″ by One Inch carriage bolts installed through the aligned holes 69 that traverse the base 60 and the corner brackets 24.

Drawing number 9/10 illustrates the apparatus' design as the same relates to diffusing the thermoelectric generators hot exhaust into four equally portioned columns of warm air.

Drawing 10/10 illustrates the apparatus' design as the same relates to extracting a fifth portion of the thermoelectric generators hot exhaust into an additional column of warm air.

Together, these elements of the invention reduce the thermoelectric generators exhaust temperature to such an extent that touchable surface temperature are attained at all exposed surface areas of the Heat Dispersing Enclosure.

1. Low power thermoelectric impressed current corrosion control installations require certain measures, such as the installation of chain link fence, in order to safeguard against possible injury resulting from persons coming in contact with the thermoelectric generators hot exhaust. Such space requirements severely limit the use of these devices.
When access to the utility electric grid is not feasible, a corrosion control operator is left with little choice but to install additional sacrificial anodes. This is becoming increasingly problematic due to the fact that coatings degrade with time which in turn results in an additional need for corrosion control current. Given the fact that sacrificial magnesium anodes are limited to a maximum driving voltage of −1.70 volt, premature replacement of metallic structure in such circumstance is assured unless an alternative and viable means of applying impressed current is developed.
Accordingly, as an operator engaged in the field of corrosion control for over 18 Years, I have taken it upon myself to develop such an alternative; a means whereby concerns for persons coming in contact with a thermoelectric generator's hot exhaust is no longer an issue. Moreover, it is my assertion that the invention described herein so successfully reduces surface temperatures along the exposed surface of the Heat Dispersing Enclosure that the claim of “touchable” can be made.
